(19) United States
(12) Patent Application Publication
(10) Pub. No.: US 2013/0060753 A1
(43) Pub. Date: Mar. 7, 2013

(54) Optimization Method And Apparatus

(71) Applicants: Maxim Lukichev, Sunnyvale, CA (US); Pankaj Mehra, San Jose, CA (US); Boris Novikov, St. Petersburg (RU)

(72) Inventors: Maxim Lukichev, Sunnyvale, CA (US); Pankaj Mehra, San Jose, CA (US); Boris Novikov, St. Petersburg (RU)

(21) Appl. No.: 13/259,249

(22) PCT Filed: Feb. 25, 2010
(86) PCT No.: PCT/US10/25414

§ 371 Date: Nov. 13, 2012

(51) Int. Cl. G06F 17/30

(52) U.S. Cl. 707/718; 707/E17.017

(57) ABSTRACT

An optimizer apparatus and method for application in a query engine of a database management system is provided for optimizing a query expression. One or more blocks are identified in the initial query expression, each of the one or more blocks being identified based on a predetermined sub-expression of the initial query expression. The optimization process is partitioned into one or more sub-tasks, wherein each sub-task corresponds to a respective block. An optimal query plan for each of the sub-tasks is determined.

### BACKGROUND

A database management system (DBMS) is a system that organizes the storage of data, and controls the creation, maintenance, and use of database storage structures. A database management system allows users to store and retrieve data in a structured way.

Database management systems are usually categorized according to the data model that they support, such as XML or relational models. The model tends to determine the query languages that are available to access data.

High-level query languages are considered as one of the most important tools provided by a database management system. With a great expressive power declarative query languages allow systems to achieve high performance. One such query language is the Structured Query Language (SQL), which is a high-level query language designed for managing data in a relational database.

It is known to use optimizers in query engines. The purpose of an optimizer is to choose an algebraic expression that is equivalent to the original query, but having a different cost of execution. Thus, if properly designed and implemented, an optimizer can significantly increase the efficiency of query processing in a database management system.

The query optimization task, i.e. the task of finding a query plan with a minimal cost estimation value, is formulated as a problem of discrete mathematical programming. The exact solution to this problem for complex queries is difficult due to large computational complexity. Moreover, it is not necessary due to the fact that cost function is a rough estimation of the actual plan cost. Therefore, in practice, query optimizers use approximate methods and heuristics that in general give near-optimal plans, rather than optimal plans.

In order to achieve high performance, the query algebra can use set-at-a-time operations (for example using operations such as relational join etc.). However, due to the algebraic properties of set-at-a-time operations, sometimes the space of equivalent plans can be extremely large, and therefore the direct use of traditional optimization techniques can often be very expensive.

### BRIEF DESCRIPTION OF THE DRAWINGS

For a better understanding of the present invention, and to show more clearly how it may be carried into effect, reference will now be made, by way of example only, to the following drawings in which:

FIG. 1 shows some basic components of a query engine of a database management system;

FIG. 2 shows a glow chart describing the steps performed by a first embodiment;

FIG. 3 represents a search space graph for a query joining three sequences: A, B, C;

FIG. 4 represents an abstract search graph having first and second blocks B1, B2 selected;

FIG. 5 shows a flow chart describing the steps performed by another embodiment;

FIG. 6 shows a flow chart describing the steps performed by yet another embodiment;

FIG. 7 shows a flow chart describing the steps performed by a further embodiment; and

FIG. 8 shows an optimizer apparatus according to an embodiment.

### DETAILED DESCRIPTION

The various embodiments described below will be given in the context of an extended markup language (XML), and in particular XQuery expressions relating to XML. It is noted, however, that the invention is applicable more widely to any form of query relating to semi-structured data in general terms.

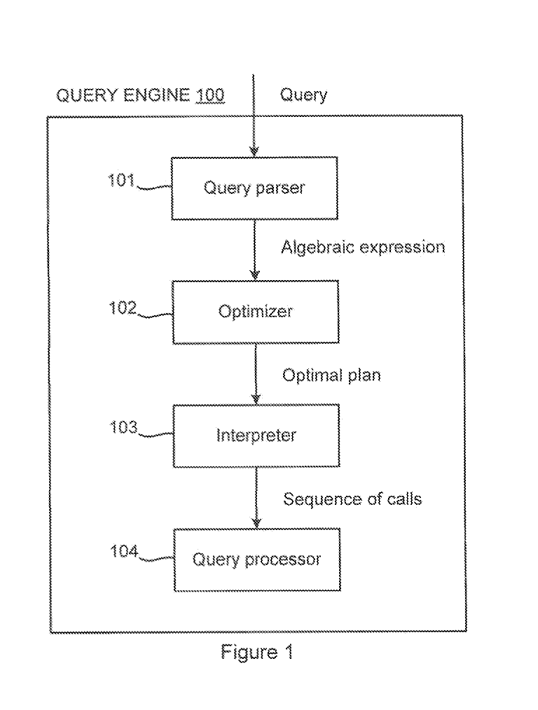

FIG. 1 shows an overview of some of the basic components that may form a query engine 100, which in turn can form part of a database management system. The query engine comprises a query parser 101 (which acts as a syntax analyzer), an optimizer 102, an interpreter 103 (which acts as a code generator) and a query processor 104 (or executor). As will be appreciated by a person skilled in the art, a query engine may comprise other units, or a different combination of units, for example interface drivers, transaction engines, relational engines and storage engines, but these have been omitted for clarity.

A query received by the query engine 100 is first checked for validity and then translated by the query parser 101 into internal form, usually an expression in terms of some algebra. To enable the query to be processed more efficiently the optimizer 102 examines a plurality of algebraic expressions that are equivalent to a given one, and selects one that is estimated to be the cheapest. In other words, the optimizer 102 is a component of a database management system that attempts to determine the most efficient way to execute a query. The interpreter (or code generator) 103 translates the query plan generated by the optimizer 102 into a sequence of calls to the query processor 104. These commands are usually referred to as an “execution plan”. The query processor 103 executes this sequence of commands.

The most complete optimization methods are based on a relational data model and its industrial analogue SQL. Relational data models provide flexibility and ad hoc query capabilities in database management systems. Optimizers of modern database management systems are able to generate query plans of very high quality (a query plan being a set of steps used to access or modify stored data).

The embodiments described herein are concerned with adapting an optimizer 102 and revising optimization methods for application in the context of semi-structured data models, for example the XML model with XQuery as a query language. Although the embodiments will be described hereinafter in relation to an optimizer and optimization method that are adapted to deal with XML and XQuery, it is noted that the optimizer method and optimizer apparatus will be applicable to any abstract algebra that allows blocks to be identified.

In order to enable query optimization, database management systems translate queries into algebraic expressions defining available transformations. In the case of XQuery, in order to achieve high performance, optimizers can have the capabilities to interchange execution of Xpath and XQuery operators. As such, query algebras that use set-at-a-time operations (i.e. atomic operations like relational join etc.) are used where possible. Furthermore, such operations have positive algebraic properties, such as commutativity and associativity. In practice this means that operations representing Xpath and FLWOR expressions can have their order changed during execution.

Algebraic expressions are usually referred to as logical or query plans. An optimizer represents a query plan as a tree of plan nodes. A plan node encapsulates a single algebraic operation that is used to execute the query. The nodes are arranged as a tree, in which intermediate results flow from the bottom of the tree to the top. Each node has zero or more “child” nodes, child nodes being nodes whose output is fed as an input to a “parent” node. A “join” node, for example, will have two child nodes, which represent the two join operands.

Embodiments described herein are concerned with providing an optimization method and optimizer apparatus for dealing with any kind of queries to any type of data that provides query algebra that enables block highlighting. For example, the embodiments are concerned with a block highlighting optimization approach to semi-structured data models, such as XML and its associated XQuery expressions. The task of query optimization is decomposed into a plurality of subtasks (i.e. dividing a search graph into smaller search graphs), each subtask corresponding to a part of the query plan. The block optimization approach is configured to work with query plans defined over set-at-a-time operations. According to one example, to identify blocks in queries over non-homogeneous data, the embodiments identify blocks according to predetermined sub-expressions of the XQuery expression.

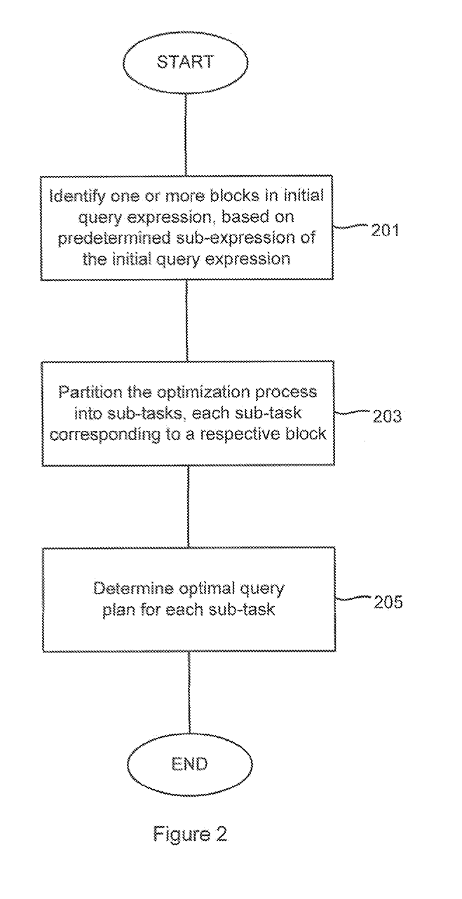

FIG. 2 shows some of the basic steps performed by an embodiment at a high level. In step 201 one or more blocks are identified in an initial query expression, i.e. one or more blocks of a search graph corresponding to an initial query. The one or more blocks are identified based a predetermined sub-expression of the initial query expression (or one or more sub-expressions). For example, as will be described in greater detail below, the one or more blocks may be identified using sub-expressions such as the “Xpath” expressions of an initial query. In step 203, once the one or more blocks have been identified as described in step 201, the optimization process is partitioned into one or more sub-tasks, each sub-task corresponding to a respective block. An optimal plan for each sub-task (or block) is then determined, step 205.

Due to the algebraic properties of set-at-a-time operations, and the large space associated with such set-at-a-time operations, the step of determining an optimal plan for each sub-task may involve an iterative process, as will be described later in the application.

Due to homogeneity of relational operations, block highlighting is not possible in the context of relational databases because join operations are homogeneous. By contrast, in the case of XQuery, join operations can be either structural or value based. Thus, according to another embodiment, the optimizer is configured to deny algebraic (associative) transformations between structural and value-based joins, which is not applicable in relational algebra.

One approach used in the construction of XQuery engines is based on the use of W3C algebra, which use logical transformation rules to improve the quality of a query plan. An alternative approach is to use flexible algebras and cost estimations for constructing an optimal plan.

The method proposed by an embodiment is based on the latter approach. The quality of the plan found during optimization depends on the space of admissible plans (equivalent algebraic expressions) among which the search is performed. The set-at-a-time execution model of operations can provide both more efficient implementations and better algebraic properties (for example commutativity, associativity etc.). This in turn can bring more efficient plans.

However, such an approach can overload the search space and can therefore complicate the task of finding an optimal or near-optimal plan, which can be especially significant in case of complex queries.

For example, if the following example of XQuery is considered:

### for $ a in A

### for $ b in B

where $ a/C=$ b
return $ b

With such an example, using plans with “set-at-a-time operations” the corresponding algebraic expression appears as:

(π(A) [symbol] _{child::}C) [symbol] =π(B)

A different order of join operations can therefore significantly affect overall performance. For example, if sequence C is joined with sequence B first by values of an equality condition, the result can then be joined with A by a parent-child relationship. This plan can be much more efficient if we have few B elements, few C elements equal to B and a large overall amount of A and C elements.

Certain data mining tasks comprise a high proportion of very complex queries, especially in the context of data mining tasks using the XQuery operations in databases such as Wikipedia™. Such queries typically comprise of tens of operators, and when such queries are mapped into algebraic expressions, they can contain hundreds of joins and other operations, the correct order of which need to be found during the optimization process. In such a case the upper bound of the search space is O(n!).

The complexity of the optimization task can be significantly reduced by the embodiments described herein through transforming the optimization task into sub-tasks corresponding to blocks of the optimization process, as described above. It will be appreciated that the complexity of optimization of each individual block will be substantially lower than the original optimization task. The block structure for the XQuery optimization task can be identified through defining blocks according to corresponding sub-expressions, such as Xpath sub-expressions, in the original query.

The transformation of the original optimization task into block-optimization can include restrictions on the search space.

Further details will now be given of the general block-optimization algorithm, and the data model and search space graph in relation to the various embodiments.

With regard to the data model, if it is assumed that there is a cost model function for each operation “a” of arity “s” (i.e. the number of operands “s” that the operation “a” can take), then the exact method of calculating the operations cost then becomes less of an issue, and instead it is assumed that the cost increases monotonically with increasing cardinality of any of the operands. The cost function reflects the computational complexity of the operation (in some metric) and has a positive value.

The cost of an arbitrary algebraic expression (function C(p)) is computed as follows:
For data extraction operations C(p)=cos t(p).
For the expression p=a(p1, p2 . . . p3) the value is calculated by the formula

$$C ( p ) = cost ( a , \vert p 1 \vert , \vert p 2 \vert … \vert p 3 \vert ) + {\sum }_{i = 1}^{s} C ( pi )$$

, where |p1| is the cardinality of set p1, |p2| the cardinality of set p2, and so forth.

From this formula it follows that the value of any expression is not less than the cost of any of its sub-expressions.

The following provides an explanation of the search space graph.

Algebraic expressions are deemed to be “equivalent” if they contain the same set of operands, and for any values of the operands that produce the same results.

The ability to record non matching equivalent expressions is based on the existence of certain equations in the algebra, such as associativity and commutativity. These equations define how plans can be transformed, and it is noted that the described embodiments are not limited to any particular equations.

An expression, resulting in a response to a query, is called an “admissible plan” for the query, and its sub-expressions are called “partial plans”.

Consider the set V of classes of equivalence of partial plans for a query.

The search space graph structure is defined on the V:let vεV—a class of equivalence, pεv:p=a(p1 . . . ps):—a representative of this class, and pᵢεvᵢ—partial plans. Then the graph contains arcs v→vᵢ.

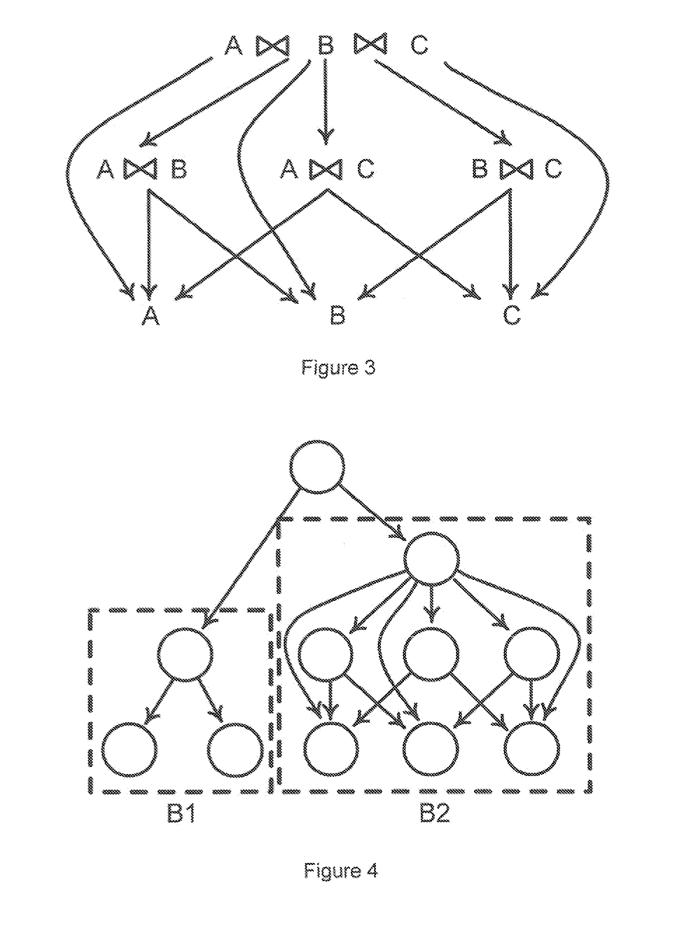

FIG. 3 represents a search space for a query that joins three relations (or sequences depending on what data model is used); A, B, C. This directed acyclic graph (DAG) represents a search space. Each node represents equivalent plans for a particular sub-query. The root node represents all equivalent plans for joining the three sequences. The leaf nodes (bottom nodes) represent different plans for accessing relations A, B, C, respectively. The middle nodes represent partial plans, joining two of the three given relations. Two nodes are connected with an edge if a target node is a sub-plan (or partial plan) for a source node.

This oriented graph has no circuits. Nodes corresponding to the full plan of the query has only outgoing arcs. Any plan corresponds to a certain set of paths in this graph, starting at the root node and ending in the classes of operations corresponding to stored data extraction (that have no outgoing arcs).

It is noted that each node of V corresponds to a query (not necessarily a sub-query of the initial query).

The plan of p is optimal, if a minimum of the function C(p) is reached on the plan in the class of equivalent plans.

Lemma—let p be an optimal plan, with a path built on the plan p. This path passes through the node vεV. Then the sub-plan pᵥ is the optimal plan for v.

In general, this is not usually applicable, as far as the number of classes of equivalence for partial plans is enormous, and it is not known which of them will be used in the optimal plan.

A subset B⊂V is termed a “block” if there is such a node v_{B}εB that for any node be BεS$ any path, passing through b, passes through v₈.

FIG. 4 represents an abstract search graph having first and second blocks B1, B2 selected. This graph shows a more complex search space compared to FIG. 3. The full execution plan shown in FIG. 4 contains two additional relation extraction operations (i.e. two additional leaf nodes) and two other binary operations whose algebraic properties do not allow operations to be interchanged with operations of B2.

Block B1 corresponds to partial plans that are organized by new operations, and B2 corresponds to the graph from FIG. 3. Due to algebraic properties of operations in this case, blocks B1 and B2 do not have any connecting edges (directly connecting).

The relevance of the concept of a “block” is in the fact that any plan containing any node of the block, also contains the node v_{B}. Thus, optimization corresponding to the block sub-query, can be performed independently of other parts of the query. This enables block-optimization to be performed with an XQuery expression.

A search for blocks in the space of plans is itself computationally expensive. As such, embodiments may use the a priori selection of blocks corresponding to a special type of sub-expression in the original query. To help ensure that these sub-queries indeed form the blocks, certain restrictions can be introduced on the use of algebraic relations.

Informally, the term “block-algorithm” used herein is intended to mean the use of different optimization algorithms for different parts of a query. It is noted, however, that the embodiments are not limited to having different optimization algorithms for different blocks. For example, the same optimization algorithm may be used in two or more blocks, or indeed in all blocks.

In other words, it does not matter whether the same algorithm is used for all blocks or not, and it does not matter whether the algorithm is precise (for example, the algorithm of dynamic programming or branch and limits) or approximation (stochastic algorithms). Of course, the quality of the plan will depend on the algorithms used, but this does not affect the basic scheme of a block-algorithm according to the various embodiments.

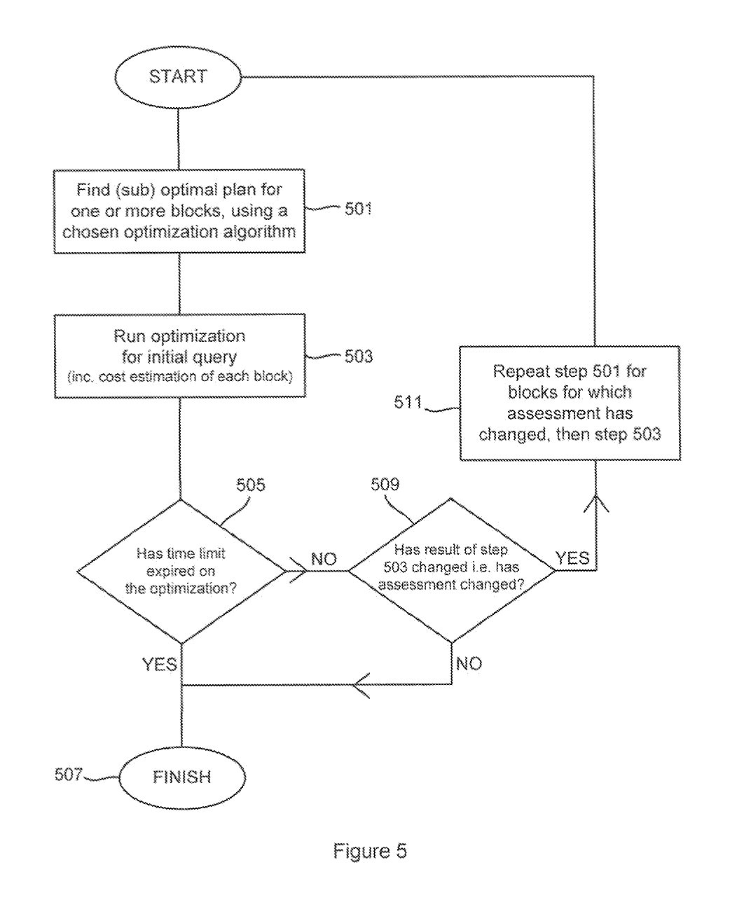

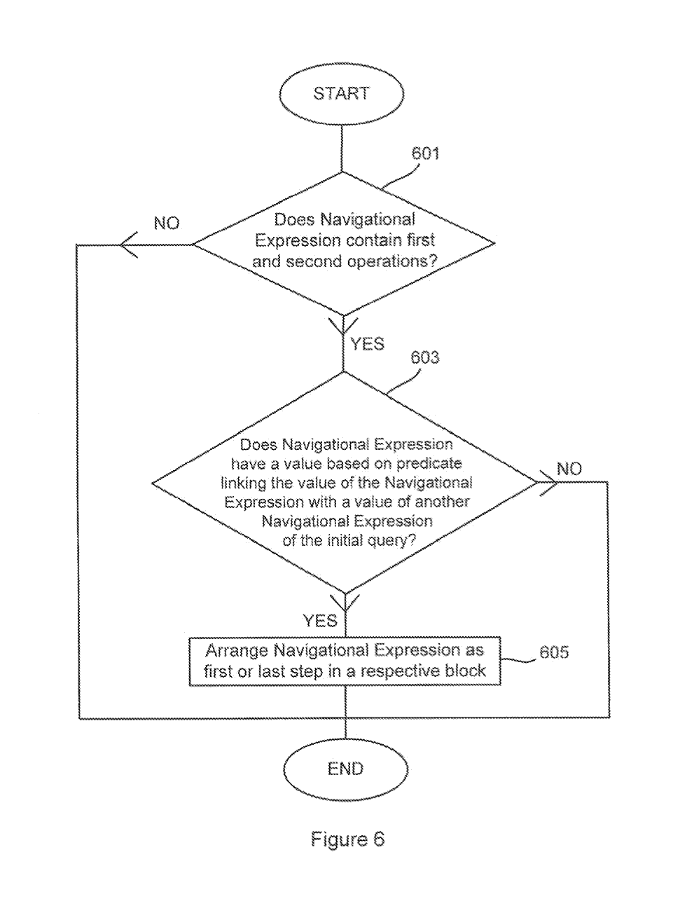

FIG. 5 shows the steps performed in an optimization task according to another embodiment. It is assumed that in the available search space, there are a plurality of blocks B₁, B₂ . . . Bₘ. It is noted that the blocks can be either leaf (i.e. blocks that do not have nodes connected with nodes of other blocks with outgoing arcs) or intermediate (i.e. blocks that do have nodes connected with nodes of other blocks with outgoing arcs). To solve the optimization task the following steps may be performed.

In step 501, during a first iteration of an initial query, a (sub) optimal plan is found for each block B₁, B₂ . . . Bₘ, using a chosen optimization algorithm. It is noted that, at this point, that for some blocks which depend on some others the valuation and cardinality of corresponding sub-expressions have not yet been calculated. In such cases a rough estimate for the sub-expression may be used. For example, the grades received on an arbitrary plan in this block.

In step 503 the optimization process is run for the initial query. This involves each block being replaced with a single indivisible operation (with cost estimations obtained during the optimization of blocks).

In step 505, it is determined whether a time limit has expired on the optimization. If so, then the optimization work is completed, step 507. A time limit is provided to prevent there being too many iterations. In query optimization there exists a trade-off between the time taken to perform the optimization process itself and the time taken to perform the actual execution. For example, there is no merit in waiting an hour for an ultimate solution, when even the best query plan cannot be executed in less that a minute. An embodiment can therefore limit the time taken during the iteration process, such that the optimization method produces the best plan that can be determined in the given time frame.

As an alternative to having a time limit, it is noted that an iteration count can also be used to limit the time taken to perform the query optimization, i.e. whereby the optimization process is completed after a predetermined number of iterations have taken place. It is noted that the time limit or iteration count may be used separately, or in combination, depending upon a particular implementation.

If it is determined in step 505 that the time limit has not expired for the optimization, it is determined in step 509 whether the result of step 503 has changed the estimations of operations, on the basis of which was carried out during optimization of one or more intermediate blocks. If so, then step 501 is repeated for those blocks for which the assessment has changed, and the procedure in step 503 repeated. In other words, a second iteration is performed, with one or more blocks whose assessment has changed being subjected to determining optimal plans for such blocks, using a chosen algorithm, and the chosen algorithm then being run for each of said blocks. During a subsequent iteration, the optimization is performed for any blocks where the assessment has changed. During the second iteration, step 505 will again determine whether or not the time limit for optimization has lapsed, and proceed to steps 507 or 509 accordingly.

If it is determined in step 509 (during a first iteration, second iteration, or any further iteration) that the assessment has not changed for any block, then the optimization process is completed, step 507.

It is therefore followed that the correctness of this algorithm follows from Lemma, as defined above.

The behaviour of the algorithm may depend on local algorithms that are applied at each step. According to one embodiment, the assessment of the plan obtained at the next iteration is compared with a predetermined assessment, for example the best available assessment, and the algorithm stopped if a global assessment (i.e. the assessment for the full plan as a whole, rather than the plan of an individual block) does not improve. The iteration is therefore completed if the obtained assessment has not improved from a previously obtained assessment.

The computation complexity of each iteration can be estimated as the sum of complexities for each block (rather than the product as in the case of a precise algorithm).

For a large class of queries an optimal plan will tend to be received after two iterations. In some situations, a plan after two iterations will be sufficient, and the optimizer can therefore be configured to time-out after two such iterations. It will be appreciated that instead of a timer per se, the optimizer may also comprise a counter as noted earlier for counting the number of iterations, such that the optimization procedure can end after a predetermined number of iterations.

It is noted that step 509 can include other heuristics, in addition or as an alternative to the time limit and iteration count mentioned above. For example, an optimization threshold level could be used in the optimization process, whereby if it is determined in step 509 that the optimization level is above an optimization threshold level, flow proceeds to step 507 (i.e. the optimization process is completed).

Further details will now be given of the optimization process for an XQuery operation, and in particular how one or more blocks for the optimization sub-tasks can be determined.

To reduce the search space and thus speed up the search for the optimal plan special heuristics to reduce the search space are used. The special heuristics reduce the search space at the expense of obviously inefficient plans. The heuristic include the exception to the direct cross product of the plans, if the product is not included in the final result of a query, and placing selective operations (i.e. operations that reduce the size of operands) as close to leafs as possible. Cross product is another algebraic operation, which can be thought of as “join” with the condition “true”. The statement outlines that if an original query does not require the cross product then the optimizer should not take into account such plans, i.e. plans containing cross products are excluded from the search space.

Thus, according to various embodiments an additional heuristic may be introduced, in order to enable the block-algorithm in the optimization of an XQuery.

A block can be defined by a lack of paths, leading to the block, that do not pass through the root node of this block. In other words, an initial query can be partitioned such that each block only has paths to that block through its root node.

This means that there are no arcs connecting other nodes of the block with nodes outside the block. As such an embodiment allocates blocks a priori (i.e. according to predetermined criteria), a ban on the use of such arcs is equivalent to a ban on the use of expressions that are outside the block and use it's internal nodes except the root one. The exclusion of such expressions in turn means a ban on the use of equivalent transformations that lead to the appearance of unwanted arcs.

According to an embodiment, as blocks it considers expressions corresponding to navigational expressions, and in particular Xpath sub-expressions of an initial query that satisfy the following conditions:

1. A navigational expression (for example Xpath) contains two operations (or steps), and

2. If a navigational expression at some step has a value based predicate linking the value of this path with the values of another sub-expression of initial query, this step should be the first or the last in the allocated block.

FIG. 6 describes some of the steps that may be performed by an optimizer during the procedure of identifying blocks for optimization. In step 601 it is determined whether a navigational expression, such as an Xpath expression, contains first and second operations. If so, in step 603 it is determined whether such a navigational expression has a value based on a predicate linking the value of the navigational expression with a value of another navigational expression of the initial query. If so, the navigational expression is arranged as the first or the last in a respective block, step 605.

It will be appreciated that the condition laid out in step 603 excludes the navigational expressions which have intermediate elements that are involved in the join operations with other sub-expressions. As a consequence, such navigational expressions will not be placed as first or last in a respective block.

Navigational expressions that violate this condition may be represented in the form of two or more blocks (unless, of course, they contain a sufficient number of steps), i.e. they satisfy condition 1 above.

In terms of algebra, the block identification procedure described above provides a ban on the associative transformations between join operations with predicates of different nature (i.e. a structural predicate and value based predicate). Depending on the form of such transformations they may, or may not, bring performance gain. For those that may improve plan quality the block identifying is affected on the further iteration of the algorithm (i.e. by dividing the block into smaller ones).

Depending on a sub-expression that forms a block, a block may be formed by not losing efficient plans, or by losing them. The type of block to be used can be pre-selected during pre-processing, and can depend on properties of a particular algebra used.

In one scenario an optimal plan can be lost, in which case, at a next iteration, the blocks of a second type can be divided into two blocks, with the rest of the iteration being performed as described.

The embodiments described herein have the advantage of providing optimization with XQuery algebras and block optimization.

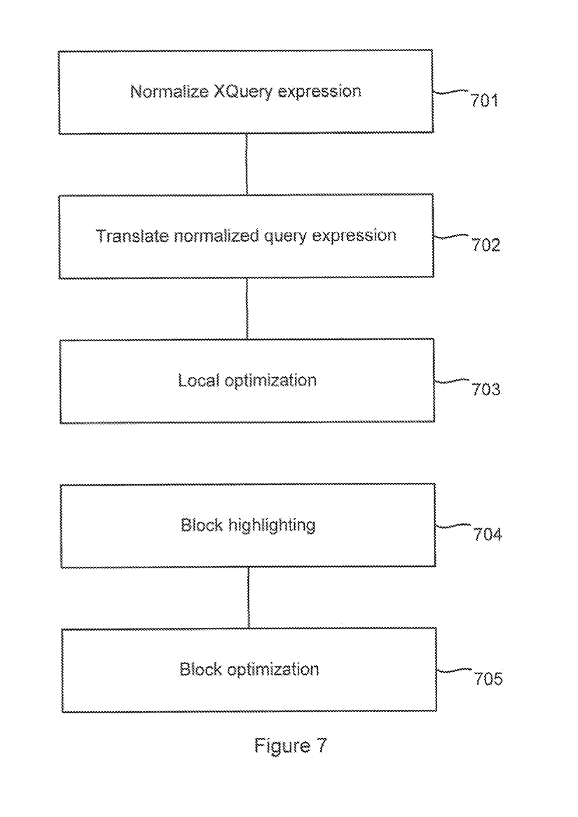

FIG. 7 describes the steps that may be performed when an embodiment is used to perform a deep mining operation.

In step 701 an XQuery expression is normalized. This involves the translation of the initial query into an equivalent query that satisfies certain conditions. For Example:

For $i [at $j] [as T] in Expr; In such expressions ‘Exp.’ is allowed to be a simple xpath. Otherwise Let-expression should wrap the ‘Expr’:

### Let $v:=Expr

### For $i [at $j] [as 1] in $v

. . . and so on.

It will be appreciated that these rules are not specific to a particular embodiment, but mostly related to the process of forming algebraic expressions for given queries. Such rules will therefore vary according to the particular algebra that is used, all of which are intended to be encompassed by the embodiments disclosed herein.

This transformation is done according to certain rules.

Next, in step 702, the normalized XQuery expression is translated. The normalized XQuery expression is translated using translation rules into an algebraic expression.

It is noted that, as mentioned above, the rules are not specific to a particular embodiment. For example, for the translation rules:

### For $v in Expr==>

P×Project_{r(E)} (E).

According to one embodiment the algebra used is XAnswer, which is an extended version of XAT algebra. XAnswer is an example of a way to utilize a set-at-a-time (join-like or relational-like) execution model in the context of XQuery. It has some common features with XAT and Galax algebras (mostly in the data model), and is a form of an extension of the above mentioned due to similarity in basic operations, revised definitions of operations for nested expression and special translation rules for building algebraic expressions, and possible optimizations.

In step 703 local optimization is performed. This may involve performing some algebraic optimizations in order to exclude some expensive operations. The optimization can be carried out according to predetermined heuristics.

In step 704 a block highlighting operation is performed, for example using one of the methods described in the embodiments above. One or more bocks can be highlighted according to certain patterns in the algebraic expression from step 703. These patterns can be defined, for example, by Xpath expressions in the query.

In step 705 block optimization is performed. This may involve an iteration process as described in the embodiments above.

It is noted that one or more of the steps described in FIG. 7 may be omitted, if desired. For example the local optimization step 703 may be omitted.

The embodiments described above have the advantage of enabling a trade-off to be made between the cost of optimization and the quality of the plans concerned. The embodiments are particularly advantageous when working with large queries.

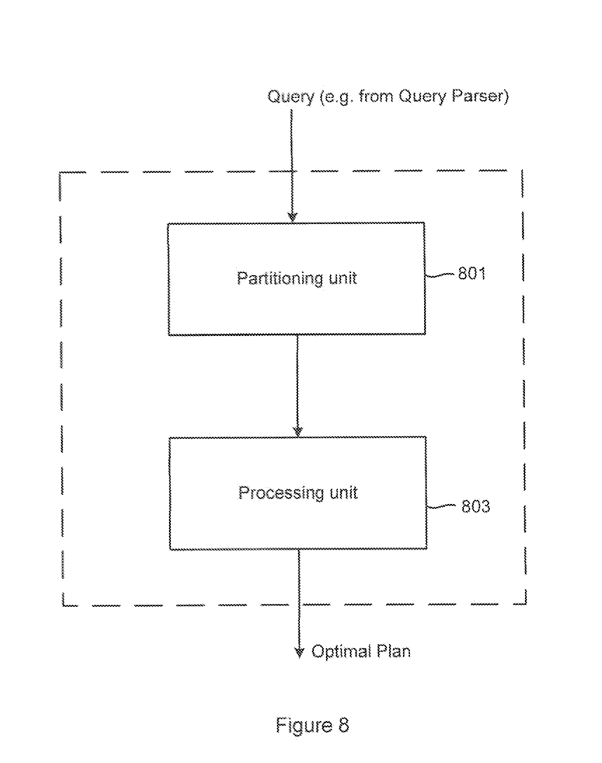

FIG. 8 shows an optimizer apparatus according to an embodiment, for optimizing the execution of an initial query expression in a query engine, for example a query engine of a database management system. The optimizer comprises a partitioning unit 801 that is adapted to partition the initial query expression into one or more blocks. Each of said one or more blocks can be identified based on a predetermined sub-expression of the initial query expression. The optimizer apparatus comprises a processing unit adapted to determine an optimal query plan for each of said blocks. The partitioning and/or processing unit may be adapted to perform other tasks, including the estimation of optimal plans for each of the one or more blocks or sub-tasks, or an iteration process for determining more optimal plans for one or more of the blocks or sub-tasks. This may include partitioning an initial block or sub-task into two or more separate blocks or sub-tasks during the iteration process.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims should not be construed so as to limit their scope.

1. An optimization method for optimizing the execution of an initial query expression in a query engine of a database management system, said method comprising the steps of:
using a partitioning unit to identify one or more blocks in the initial query expression, each of said one or more blocks being identified based on a predetermined sub-expression of the initial query expression;
partitioning an optimization process into one or more sub-tasks, wherein each sub-task corresponds to a respective block identified by said identifying step; and
using a processing unit to determine an optimal query plan for each of said sub-tasks.

2. A method as claimed in claim 1, wherein said step of determining an optimal query plan for each of said sub-tasks comprises the steps of:
executing the optimization process for each sub-task of said initial query expression; and,
using a result of said execution step to repeat the step of determining an optimal query plan for one or more of the sub-tasks.

3. A method as claimed in claim 2, wherein said steps of executing and determining an optimal query plan are iterated.

4. A method as claimed in claim 3, wherein said iteration is performed a predetermined number of times.

5. A method as claimed in claim 4, wherein during each iteration an assessment of a query plan is obtained and compared with a predetermined assessment, and wherein the iteration is completed if the obtained assessment has not improved from a previously obtained assessment.

6. A method as claimed in claim 1, wherein said initial query expression relates to an extended markup language (XML) database query.

7. A method as claimed in claim 6, wherein said predetermined sub-expression of said initial query expression relates to a specific XQuery sub-expression.

8. A method as claimed in claim 7, wherein said specific XQuery sub-expression relates to a navigational expression.

9. A method as claimed in claim 8, wherein said navigational expression corresponds to an Xpath sub-expression in the initial query expression.

10. A method as claimed in claim 8, further comprising the steps of:
determining if said navigational expression contains first and second operations;
determining if said navigational expression has a value based on a predicate linking the value of said navigational expression with the value of another sub-expression of the initial query expression; and, if the conditions of both of said determining steps are met;
allocating said navigational expression as a first or a last in a respective block.

11. A method as claimed in claim 1, further comprising the steps of:
translating said initial query expression into relational algebraic equations defining a set of available transformations; and
preventing algebraic transformations between structural and value-based joins of said initial query expression in said set of available transformation.

12. A method as claimed in claim 1, wherein each block is identified such that each block only has paths to that block through a respective root node of that block.

13. A method as claimed in claim 1, wherein the step of block identification excludes associative transformations between join operations with predicates of a different nature.

14. A method as claimed in claim 13, wherein the predicates relate to a structural predicate and value based predicate.

15. A computer readable medium having stored thereon computer program instructions that, when executed by a processor, cause a computer system to:
identify one or more blocks in an initial query expression of a database management system, each of said one or more blocks being identified based on a predetermined sub-expression of the initial query expression;
partition the optimization process into one or more sub-tasks, wherein each sub-task corresponds to a respective block identified by said identifying step; and
determine an optimal query plan for each of said sub-tasks.

16. An optimizer apparatus for optimizing the execution of an initial query expression in a query engine; said optimizer apparatus comprising:
a partitioning unit adapted to partition the initial query expression into one or more blocks, each of said one or more blocks being identified based on a predetermined sub-expression of the initial query expression; and
a processing unit adapted to determine an optimal query plan for each of said blocks.

17. An optimizer apparatus as claimed in claim 16, wherein said processing unit is adapted to execute an optimization process for each block of said initial query expression and, determine an optimal query plan for one or more of the sub-tasks using a result of said execution.

18. An optimizer apparatus as claimed in claim 17, wherein said processing unit is adapted to iterate the execution of the optimization process and determination of said optimal query plan.

19. An optimizer apparatus as claimed in claim 18, wherein said processing unit is adapted to perform the iteration process a predetermined number of times.

20. An optimizer apparatus as claimed in claim 19, wherein the processing unit is adapted to determine an assessment of a query plan during each iteration step, and further adapted to compare the assessment with a predetermined assessment, and complete the iteration process if the obtained assessment has not improved from a previously obtained assessment.

21. An optimizer apparatus as claimed in claim 16, wherein said initial query expression relates to an extended markup language (XML) database query.

22. An optimizer apparatus as claimed in claim 21, wherein said predetermined sub-expression of said initial query expression relates to a specific XQuery sub-expression.
